(19) United States
(12) Patent Application Publication
(10) Pub. No.: US 2014/0079503 A1
(43) Pub. Date: Mar. 20, 2014

(54) BOBBIN, ANCHORING ASSEMBLY AND METHOD OF USING SAME

(71) Applicant: Ronald M. Hutchinson, Brookfield, WI (US)

(72) Inventor: Ronald M. Hutchinson, Brookfield, WI (US)

(21) Appl. No.: 13/618,497

(22) Filed: Sep. 14, 2012

(51) Int. Cl. B60P 7/06

(52) U.S. Cl. CPC B60P 7/06
USPC 410/101

(57) ABSTRACT

A bobbin is provided and can be attached to almost any part of a surface for securing an item to the surface using an elasticized cord with hook ends. In one embodiment, a pre-existing fastener can be removed and replaced with a slightly longer fastener to mount the bobbin at that point. Where placement of the bobbin is made at a point where no pre-existing fastener exists, a bobbin and fastener can be placed there by simply drilling a hole and fastening the bobbin at that point. The present invention further provides an assembly that comprises a plurality of such bobbins, the bobbins being strategically located for securing particular types of items. It also provides the method for locating, fastening and using the assembly of bobbins.

### FIELD OF THE INVENTION

The present invention relates generally to devices and fasteners used to secure one or more items to another item. It also generally relates to motorcycles, including trike motorcycles (collectively, “motorcycles”), and to accessories for motorcycles. More specifically, the present invention relates to a bobbin-shaped structure (or, simply, a “bobbin”) that can be mounted to certain surfaces of another structure, including a motorcycle, for the purpose of attaching or guiding an elasticized cord with a wire hook at each end (also called a “bungee cord”) to or around the bobbin. The present invention also relates specifically to an anchoring assembly that uses a plurality of such bobbins and to a method of using the anchoring assembly and bobbins to secure lightweight loads to a motorcycle where the bobbins are selectively positioned within existing cycle structures by replacing existing fasteners or are positioned by adding new bobbin anchoring points to a surface.

### BACKGROUND OF THE INVENTION

There are a number of devices and structures known in the art that can be used for tying down or anchoring bungee cords. Some of these structures are tie down rings, loops, bars or fingers, among others. In the recreational sport of motorcycling, it is also known that most motorcycles have a limited capacity for stowing articles for transport. Accordingly, it is often necessary to secure supplemental carrying articles or loads to motorcycles to increase the transport capacity of the motorcycle. In the experience of this inventor, motorcycles also have a somewhat limited number of points that can suitably serve as anchor points for straps and tie-downs for these types of supplemental carrying structures.

In the case of the typical bungee cord, for example, the edge of fender may be used as an anchor point for one wire hook end of the bungee cord. But such is done at the risk of the fender being scratched by the wire hook end which is typically made of metal wire for strength. Worse yet, the end of the bungee cord will be pulled to the point of least resistance along the arc of the fender which may not be the most useful, or the strongest, anchor point for the supplemental carrying structure, article or load. In other instances, the bungee cord may be of a length where some of its slack needs to be taken up in order to adequately anchor the extra baggage. In those instances, there may not be, and there typically is not, a suitable structure around which the bungee cord may be safely and securely looped particularly where several passes of the cord over the article, or multiple cords, are required to secure that extra baggage load.

In the view of this inventor, there is a clear need to provide a bobbin-type structure (or, simply, a “bobbin”) that can be mounted into certain surfaces of a motorcycle for the purpose of attaching or guiding a strap with anchoring means, such as a “bungee cord,” to and around the bobbin as is desired or required. There is also a need to provide an anchoring assembly that would use a plurality of such bobbins and to provide a method of using the anchoring assembly and bobbins for the purpose of securing lightweight loads to a motorcycle. In this last regard, such bobbins can be mounted in certain locations where existing mounting or fastening means can be removed and replaced by the bobbin and its mounting structure. But there is also a need to provide such bobbins in other locations within the structure of the motorcycle to maximize the motorcycle's capacity to carry supplemental articles or loads using bungee cords but where no pre-existing fastener is present.

Accordingly, it is an object of the present invention to provide a bobbin that can be mounted to the surface of a motorcycle for the purpose of attaching or guiding a strap with anchoring means to or around the bobbin. It is another object to provide an anchoring assembly that uses a plurality of such bobbins. It is yet another object to provide a method of using the anchoring assembly and bobbins to secure lightweight loads to a s motorcycle where the bobbins are selectively positioned within existing cycle structures by replacing existing fasteners or are positioned by adding new bobbin anchoring points to the motorcycle.

### SUMMARY OF THE INVENTION

The present invention has obtained these objects. It provides for a bobbin that be attached to almost any part of a motorcycle, including tour pack lids, fenders, fender mounts, license plate brackets, saddlebag mounts, among other areas. The present invention requires the removal of one fastener and using a slightly longer fastener where placement is made at the point of the pre-existing fastener. Where the placement is made at a is point where no pre-existing fastener exists, a bobbin and fastener can be placed there by simply drilling a hole and fastening the bobbin at that point. The present invention further provides an assembly that comprises a plurality of such bobbins, the bobbins being strategically located for securing particular types of items. It also provides the method for locating, fastening and using the assembly of bobbins.

The foregoing and other features of the device, system and method of the present invention will be apparent from the detailed description that follows.

### BRIEF DESCRIPTION OF THE DRAWINGS

FIG. 1 is top and side perspective view of a bobbin that is constructed in accordance with the present invention.

FIG. 2 is a side elevational view of the bobbin shown in FIG. 1.

FIG. 3 is a top plan view of the bobbin shown in FIG. 1.

FIG. 4 is a side elevational view of a bobbin as installed on a surface in accordance with the present invention.

FIG. 5 is an enlarged partial side view of the bobbin and illustrating how multiple bungee hook wires could be secured to the bobbin.

FIG. 6 is a perspective view of the rear of a trike motorcycle and showing multiple attachment points for a plurality of bobbins that are used in accordance the present invention.

### DETAILED DESCRIPTION

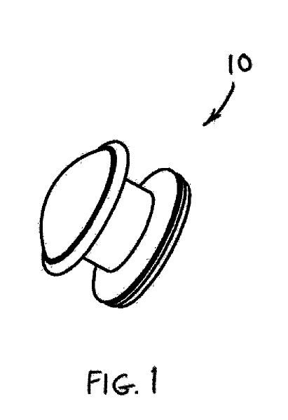

Referring now to the drawings in detail, wherein like numbered elements refer to like elements throughout, FIGS. 1 through 3 illustrate a representative structure, generally identified 10, which is a preferred embodiment of a bobbin that is fabricated in accordance with the present invention.

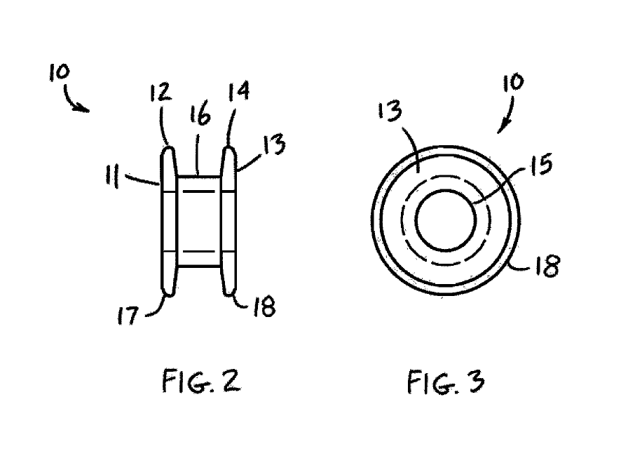

Now referring specifically to FIG. 2, it illustrates a side elevational view of the bobbin 10. The bobbin 10 generally comprises a first circular end flange 12, a second circular end flange 14 and a cylindrical central portion 16 extending between the end flanges 12, 14. Each end flange 12, 14 has an outer face 11, 13, respectively, and a diameter. The diameter of each end flange 12, 14 is significantly greater than the diameter of the central portion 16. This greater diameter assures adequate anchoring of a bungee cord or the bungee cord hook wire ends, as will be apparent later in this detailed description. The wide flanges 12, 14 also insure suitable alignment while minimizing the risk that a hook wire end will damage adjacent body surfaces when the bobbin 10 is used as intended.

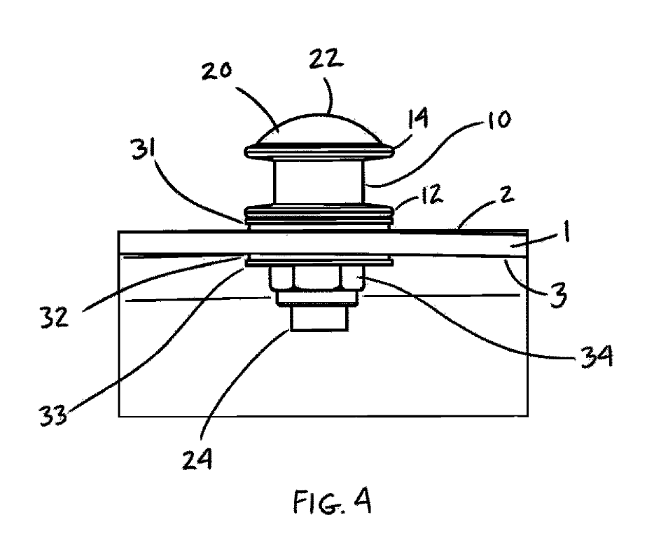

As shown in FIG. 3, the flanges 12, 14 and the central portion 16 comprise a common core aperture 15 that extends between the outer faces 11, 13 of the end flanges 12, 14, respectively. It is to be noted that the bobbin 10 is symmetrical. It is also to be noted that the peripheral edges 17, 18 of the flanges 12, 14 are chamfered to provide a smooth surface about the edges 17, 18 and to provide a surface that matches the round head 22 of a fastener 20. As shown in FIG. 4, the fastener 20 is a round head bolt where the head 22 would include a drive feature, such as a hex drive receiver.

Continuing to refer to FIG. 4, it illustrates the bobbin 10 of the present invention as it would be secured to a structure or surface 1, the structure or surface 1 having an outer face 2 and an inner face 3. Although the preferred embodiment of the present invention contemplates that the surface 1 is that of a motorcycle, it is within the scope of the present invention that the device, assembly and method of the present invention could be used for attaching objects to any number of other objects.

As shown, the fastener 20 further comprises a threaded end 24. It is to be understood that a shaft (not shown) extends between the round head 22 and the threaded end 24 of the fastener 20. The fastener 20 extends through a round aperture (not shown) within the structure or surface 1. The outer face 2 is adjacent the outer face 11 of the flange 12, with a gasket 31 interposed between those two structures. The bottom surface of the round head 22 is adjacent the outer face 13 of the flange 14. Below the planar structure 1, a gasket 32 is adjacent the inner face 3 with a washer 33 interposed between that gasket 32 and a threaded nut 34, the threads of the nut 34 meshing with the threads of the threaded end 24 of the fastener 20. It is also to be noted that, when fastened to the structure or surface 1, the bobbin 10 does not rotate.

As previously alluded to, the bobbin 10 can be attached to a surface 1 using an existing fastener (not shown) and existing structure (also not shown) of the motorcycle. For example, the point at which a fastener is used to anchor a portion of a fender might be one such existing structure. However, the bobbin 10 of the present invention can also be attached at other points as may be required or desired by the user.

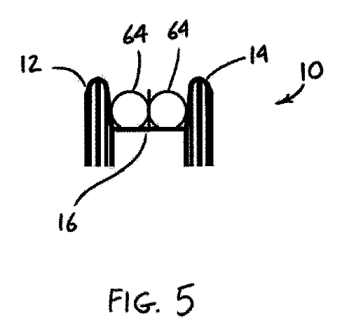

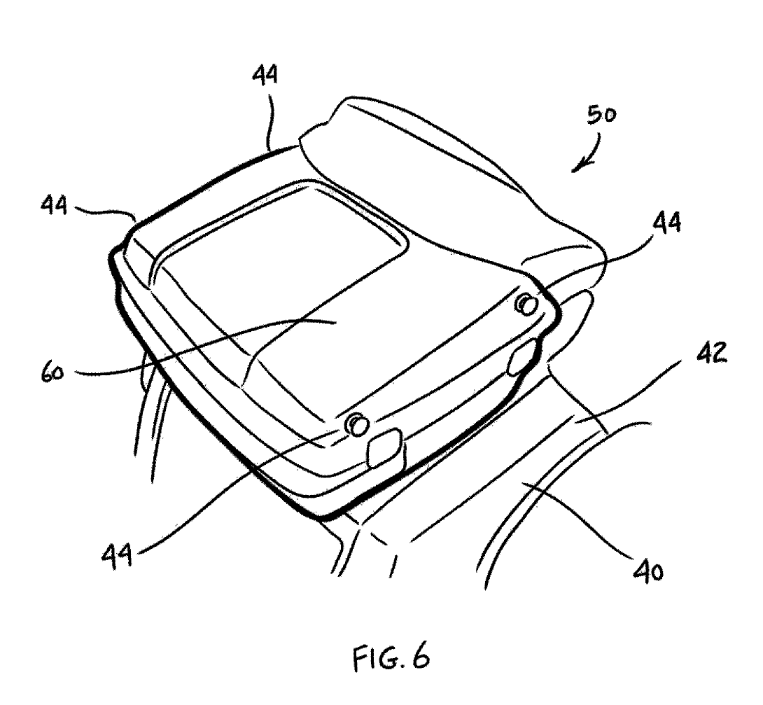

An assembly, generally identified 50, comprising a plurality of bobbins 10 can be attached to the surfaces 42 of a motorcycle 40, as shown in FIG. 6. It is to be understood that virtually any surface 42 of the motorcycle 40 structure can be used for that assembly 50, which assembly 50 also includes at least one bungee cord 60, the bungee cord 60 comprising two hook wires 64, each disposed at one end of the cord 60. As shown in FIG. 5, the central portion 16 of the bobbin 10 is dimensioned to receive the width or thickness of two hook wires 64 of the bungee cord 60, or two hook wires 64 from different bungee cords 60.

In application, the user determines the locations 44 along the surface 42 of the motorcycle 40, or other object, that would be desirable for use of the bobbins 10 to support or secure a load item (or, simply, “item”) to the motorcycle 40. This forms the assembly 50 as previously discussed. The assembly 50 forms a bobbin configuration. If a location 44 is one that has a fastener already in use, that fastener can be removed and replaced with the bobbin 10 and fastener 20 as previously described. If a location 44 is one that does not have a fastener already in use, an aperture can be drilled into the surface 42 at that location 44 and a bobbin 10 can be placed at that location 44.

With all bobbins 10 placed within the configuration, the item to be held down is situated and the necessary bungee cords 60 are applied to the item and to the bobbins 10, thereby securing the item to the motorcycle 40.

It is also within the scope of the present invention to have the head portion 22 of the fastener 20 match the outer surfaces of the bobbin 10 or bobbins 10 such that the bobbin 10 and fastener appear as a single solid structure for aesthetics. Further, such surfaces could be finished by anodizing, chrome plating, painting or such other surface finishing method, all of which are within the scope of the present invention.

The details of the invention having been disclosed in accordance with the foregoing, I claim:

1. A bobbin for use with a surface, the surface comprising an outer face, the bobbin comprising:
a first circular end flange, the flange having an outer face;
a second circular end flange, the flange having an outer face;
a cylindrical central portion extending between the end flanges;
an aperture formed in the flanges and the central portion and extending from the outer face of the first end flange to the outer face of the second end flange; and
a fastener for attaching the bobbin to the outer face of the surface.

2. The bobbin of claim 1 wherein the surface further comprises an inner face and an aperture extending between the outer face and the inner face of the surface and the fastener extends through the surface aperture.

3. The bobbin of claim 2 wherein the fastener comprises a round headed bolt and wherein the bobbin end flanges are chamfered about the peripheral edges to provide a surface that matches the round head of the bolt.

4. The bobbin of claim 3 wherein the round head of the bolt further comprises a drive feature.

5. The bobbin of claim 4 wherein the fastener replaces a pre-existing fastener used within the surface aperture.

6. An assembly for anchoring an item to a surface, the assembly comprising a plurality of selectively-positioned bobbins and each bobbin comprising:
a first circular end flange, the flange having an outer face;
a second circular end flange, the flange having an outer face;
a cylindrical central portion extending between the end flanges;
an aperture formed in the flanges and the central portion and extending from the outer face of the first end flange to the outer face of the second end flange; and
a fastener for attaching each bobbin to a surface.

7. The anchoring assembly of claim 6 wherein the surface further comprises an outer face, an inner face and a plurality of apertures extending between the outer face and the inner face of the surface and each fastener extends through a surface aperture.

8. The anchoring assembly of claim 7 wherein each fastener comprises a round headed bolt and wherein the bobbin end flanges are chamfered about the peripheral edges to provide a surface that matches the round head of the bolt.

9. The anchoring assembly of claim 8 wherein the round head of the bolt further comprises a drive feature.

10. The anchoring assembly of claim 9 wherein at least one of the fasteners replaces a pre-existing fastener within a surface aperture.

11. A method of using an assembly for anchoring an item to a surface, the assembly comprising a plurality of bobbins and each bobbin comprising:
a first circular end flange, the flange having an outer face;
a second circular end flange, the flange having an outer face;
a cylindrical central portion extending between the end flanges;
an aperture formed in the flanges and the central portion and extending from the outer face of the first end flange to the outer face of the second end flange; and
a fastener for attaching each bobbin to a surface;
the method comprising the steps of:
providing the plurality of bobbins;
selectively positioning each bobbin at a point on at least one surface;
fastening each bobbin at the point at which the bobbin is selectively positioned;
positioning an item wherein the item can be secured to the at least one surface;
providing at least one elastic cord, the at least one elastic cord having two ends and a wire hook at each end; and
using the at least one elastic cord to secure the item to the surface via attachment of the wire hooks to the plurality of bobbins and/or guiding the elastic cord around the plurality of bobbins.

12. The anchoring method of claim 11 wherein the surface further comprises an outer face, an inner face and a plurality of apertures extending between the outer face and the inner face of the surface and each fastener extends through a surface aperture.

13. The anchoring method of claim 12 wherein each fastener comprises a round headed bolt and wherein the bobbin end flanges are chamfered about the peripheral edges to provide a surface that matches the round head of the bolt.

14. The anchoring method of claim 13 wherein the round head of the bolt further comprises a drive feature.

15. The anchoring method of claim 14 wherein at least one of the fasteners replaces a pre-existing fastener within a surface aperture.
